(19) United States
(12) Patent Application Publication
(10) Pub. No.: US 2026/0081405 A1
(43) Pub. Date: Mar. 19, 2026

(54) PROTECTOR AND WIRE HARNESS

(71) Applicant: Sumitomo Wiring Systems, Ltd., Yokkaichi-shi (JP)

(72) Inventors: Yuji OKAMOTO, Yokkaichi-shi (JP); Masao SUZUKI, Yokkaichi-shi (JP); Hideki HATTORI, Yokkaichi-shi (JP); Atsushi ONO, Yokkaichi-shi (JP); Toru KAWAMIYA, Yokkaichi-shi (JP); Katsumoto MIZUTANI, Yokkaichi-shi (JP); KOKI KURITSUBO, Yokkaichi-shi (JP); Shota MORIKAWA, Yokkaichi-shi (JP)

(73) Assignee: Sumitomo Wiring Systems, Ltd., Yokkaichi-shi (JP)

(21) Appl. No.: 19/327,857

(22) Filed: Sep. 12, 2025

(30) Foreign Application Priority Data
Sep. 13, 2024 (JP) 2024-159081

(51) Int. Cl. H02G 3/04; B60R 16/02

(52) U.S. Cl. CPC H02G 3/04; B60R 16/0215

(57) ABSTRACT

A protector includes: a housing that has a pair of side walls facing each other in a width direction and a bottom wall connecting lower ends of the pair of side walls, and is configured to house a wire group between the pair of side walls; and outlets that are provided at both ends of the housing in a length direction of the wire group and are configured to lead the wire group out of the housing.

This application claims priority from Japanese Patent Application No. 2024-159081 filed Sep. 13, 2024, the entire disclosure of which is incorporated herein by reference.

### BACKGROUND

The present disclosure relates to a protector and a wire harness.

Conventionally, a protector used for, e.g., a vehicle wire harness includes a housing that has a pair of side walls facing each other and a bottom wall connecting the lower ends of the pair of side walls (see JP 2006-246663A, for example). A wire group consisting of a plurality of wires is housed between the pair of side walls of the housing. The wire group is led out of the protector from both ends of the housing. The protector of JP 2006-246663A is provided with a cover that covers an opening between the upper ends of the pair of side walls.

### SUMMARY

In the above-described protector, due to limited placement space or other reasons, there may be a case where the protector is designed with a small dimension in the height direction and the cover cannot be set over the entire or part of the housing in the length direction. In this case, in the region where the cover cannot be set, the opening between the upper ends of the pair of side walls can be closed by wrapping tape around the outer periphery of the housing. Also, when the housing has a small dimension in the height direction and the cover cannot be set, the rigidity of the housing is reduced, possibly causing a deformation in the region where the cover cannot be set due to the bending reaction force of the wire group or the like. To prevent such a deformation in the region where the cover cannot be set, it is conceivable to provide a reinforcement part extending from, for example, at least the upper end of each of the side walls outward in the width direction, thereby improving the rigidity of this region. However, in this case, the upper end of the side wall is thickened by the reinforcement part, and thus there is a risk that wires may be taped while riding up on the reinforcement part at the upper end of the side wall.

An exemplary aspect of the disclosure provides a protector and a wire harness that can prevent wires from being taped while riding up on a side wall.

A protector according to the present disclosure includes: a housing that has a pair of side walls facing each other in a width direction and a bottom wall connecting lower ends of the pair of side walls, and is configured to house a wire group between the pair of side walls; and outlets that are provided at both ends of the housing in a length direction of the wire group and are configured to lead the wire group out of the housing, wherein the side walls include, in an intermediate portion of the housing in the length direction, a reinforcement side wall that has a reinforcement part extending outward in the width direction from at least an upper end of one of the side walls, an upper end face of the reinforcement side wall has an inclined portion that is inclined downward and inward in the width direction and is connected to an inner face of the reinforcement side wall, and a tape is wound around an outer periphery of the housing in a range in the length direction that includes at least a portion of the inclined portion, so that a space between the upper ends of the pair of side walls is closed by the tape.

According to the protector and wire harness of the present disclosure, it is possible to prevent wires from being taped while riding up on a side wall.

### BRIEF DESCRIPTION OF THE DRAWINGS

FIG. 1 is a perspective view showing a wire harness according to an embodiment.

FIG. 2 is a plan view showing a protector according to the embodiment.

FIG. 3 is a cross-sectional view taken along a line 3-3 in FIG. 2.

FIG. 4 is a cross-sectional view taken along a line 4-4 in FIG. 2.

### DETAILED DESCRIPTION OF EMBODIMENTS

### Description of Embodiments of the Present Disclosure

Embodiments of the present disclosure will be first listed and described.

According to the present disclosure,
[1] A protector according to the present disclosure includes: a housing that has a pair of side walls facing each other in a width direction and a bottom wall connecting lower ends of the pair of side walls, and is configured to house a wire group between the pair of side walls; and outlets that are provided at both ends of the housing in a length direction of the wire group and are configured to lead the wire group out of the housing, wherein the side walls include, in an intermediate portion of the housing in the length direction, a reinforcement side wall that has a reinforcement part extending outward in the width direction from at least an upper end of one of the side walls, an upper end face of the reinforcement side wall has an inclined portion that is inclined downward and inward in the width direction and is connected to an inner face of the reinforcement side wall, and a tape is wound around an outer periphery of the housing in a range in the length direction that includes at least a portion of the inclined portion, so that a space between the upper ends of the pair of side walls is closed by the tape.

According to this configuration, if wires ride up on the inclined portion during tape winding, the wires will be pushed into the housing by the tape in the process of winding. In this way, the inclined portion can guide the wires into the housing. Therefore, it is possible to prevent the wires from being taped while riding up on the reinforcement side wall.
[2] In the above-described configuration [1], the housing may include a first range, which is a range of the housing in the length direction and includes the reinforcement side wall, and a second range, which is a range in the length direction other than the first range, a width direction dimension of the pair of side walls in the second range may be smaller than a width direction dimension of the reinforcement side wall having the reinforcement part, and a cover may be provided in the second range, the cover having a thickness in a height direction larger than that of the tape and covering the space between the upper ends of the pair of side walls.

According to this configuration, since the cover that covers the space between the upper ends of the pair of side walls is provided in the second range of the housing, it is possible to improve the rigidity in the second range with the cover.
[3] In the above-described configuration [2], the housing may have a flattened shape with a small thickness in the height direction over the entire length in the length direction, and the thickness of the housing in the height direction may be smaller in the first range than in the second range.

According to this configuration, it is possible to ensure the rigidity in the first range with the reinforcement part, while reducing the thickness of the housing in the height direction in the first range.
[4] In any one of the above-described configurations [1] to [3], the inclined portion may be formed in the upper end face of the reinforcement side wall, partially in the width direction.

According to this configuration, it is possible to form the inclined portion, while securing the cross-sectional area (i.e., rigidity) of the reinforcement side wall.
[5] In any one of the above-described configurations [1] to [4], the reinforcement side wall may have a pair of fixing portions that extend from an outer face in the width direction of the reinforcement side wall and are lined up in the length direction, a range in the length direction between the pair of fixing portions may be a wrappable range that is wrappable by the tape, and the inclined portion may be provided over a range in the length direction that includes at least the wrappable range.

According to this configuration, the inclined portion provided over a range including the tape wrappable range can effectively prevent wires from riding up on the reinforcement side wall.
[6] In any one of the above-described configurations [1] to [5], a pair of the reinforcement side walls each including the inclined portion may be provided facing each other in the width direction.

According to this configuration, in the intermediate portion of the housing in the length direction, each of the pair of side walls is provided with a reinforcement part and an inclined portion, so it is possible to further prevent wires from being taped while riding up on the reinforcement side wall.

[7] A wire harness according to the present disclosure includes: the protector according to any one of the configurations [1] to [6]; and a wire group passing through the protector.

According to this configuration, in the wire harness including the wire group and the protector, it is possible to prevent wires from being taped while riding up on the reinforcement side wall of the protector.

### Details of Embodiments of the Present Disclosure

The following will describe specific examples of the protector and wire harness of the present disclosure with reference to the drawings. In the drawings, some of the configurations may be exaggerated or simplified, for convenience of explanation. In addition, the proportion of dimensions of each part may differ between the drawings. The expression “orthogonal” in the present specification includes not only the case of strictly orthogonal, but also the case of approximately orthogonal within the scope where functions and effects of the embodiments are achieved.

The expression “flattened shape” in the present specification includes rectangular, oval, and elliptical shapes. In addition, the expression “facing” in the present specification refers to the case where faces or members are located in front of each other, including the case where they are located precisely in front of each other as well as the case where they are located partially in front of each other. Also, the expression “facing” in the present specification includes both the case where two parts face each other with a member different from the two parts interposed therebetween and the case where they face each other without any member interposed therebetween. In addition, terms such as “first” and “second” in the present specification are used simply to distinguish between objects and are not intended to rank objects. The present disclosure is not limited to the examples but rather defined by the claims, and all modifications within the meaning and scope equivalent to the claims are intended to be included.

### Configuration of Wire Harness 10

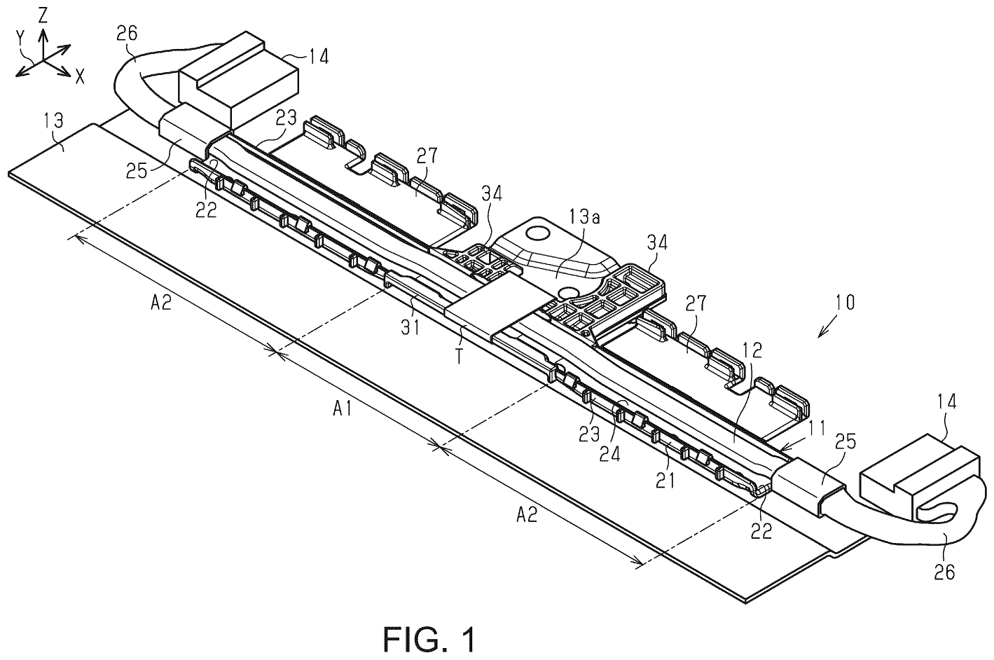

As shown in FIG. 1, a wire harness 10 of the present embodiment includes a protector 11 and a wire group 12 passing through the protector 11. The wire harness 10 is assembled into, for example, a vehicle battery module. The protector 11 is placed on a bracket 13 for fixation. Above the protector 11, a fire-resistant top panel (not shown) of the battery module is placed, for example.

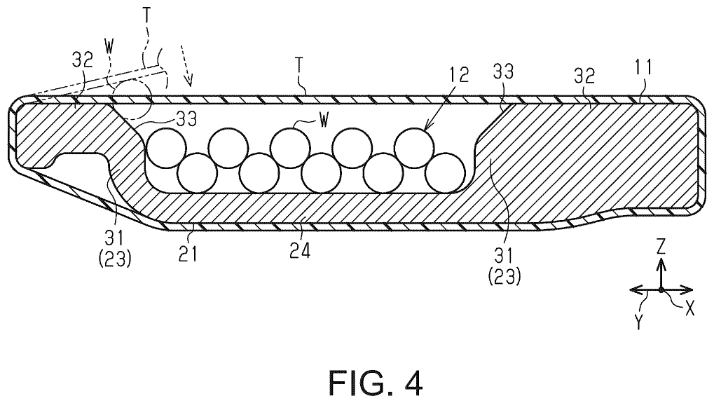

The wire group 12 includes a plurality of wires W (see FIG. 4). The plurality of wires W are each a coated wire including an insulating coating. Inside the protector 11, the wire group 12 is in a state where the plurality of wires W are not bundled together by a tape or the like. The protector 11 has a substantially linear shape along a length direction X of the wire group 12. Note that three directions, namely, the length direction X, a width direction Y, and a height direction Z are orthogonal to each other. The wire group 12 is drawn out of the protector 11 from both ends of the protector 11 in the length direction X. Connectors 14 are provided at respective ends of the wire group 12 drawn out of the protector 11. Each of the connectors 14 is connected to a not-shown counterpart connector.

### Configuration of Protector 11

The protector 11 includes a housing 21 extending in the length direction X, and outlets 22 provided at respective ends of the housing 21 in the length direction X.

### Configuration of Housing 21

The housing 21 has a pair of side walls 23 facing each other in the width direction Y, and a bottom wall 24 connecting the lower ends of the pair of side walls 23. The side walls 23 and the bottom wall 24 extend over the entire housing 21 in the length direction X. The housing 21 has a flattened shape with a small thickness in the height direction Z over the entire length in the length direction X. That is, the dimension of each side wall 23 in the height direction Z is smaller than the dimension of the bottom wall 24 in the width direction Y.

Between the pair of side walls 23 of the housing 21, the wire group 12 is housed along the length direction X. The wire group 12 is drawn out of the housing 21 from the outlets 22. The wire group 12 is fixed to the protector 11 by a binding member 25 such as a tape or a binding band at each of the outlets 22. Note that the wire group 12 led out from each of the outlets 22 may be covered by, for example, an exterior member 26.

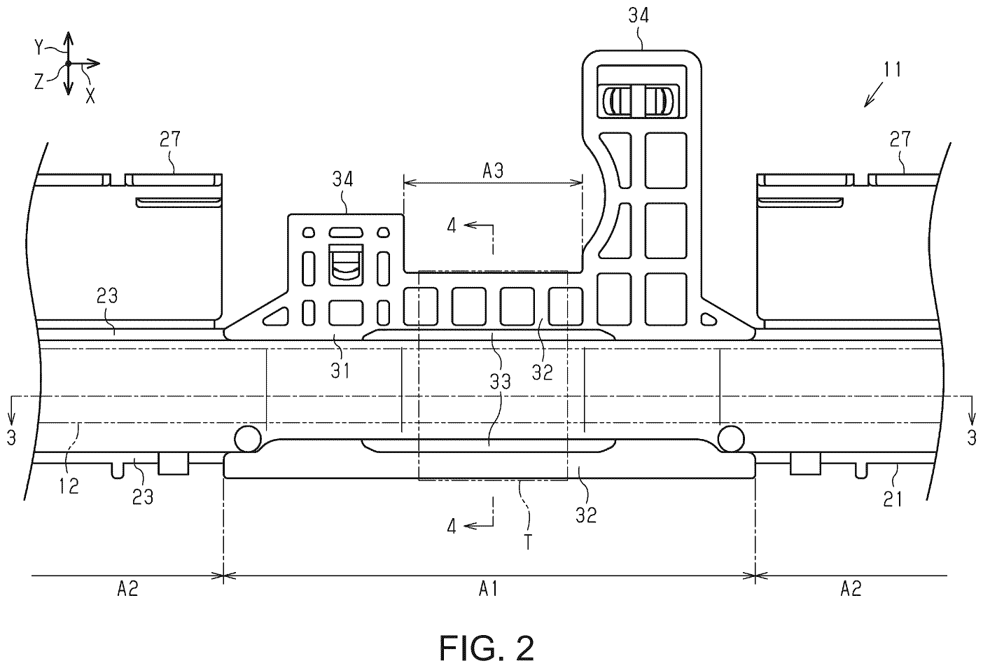

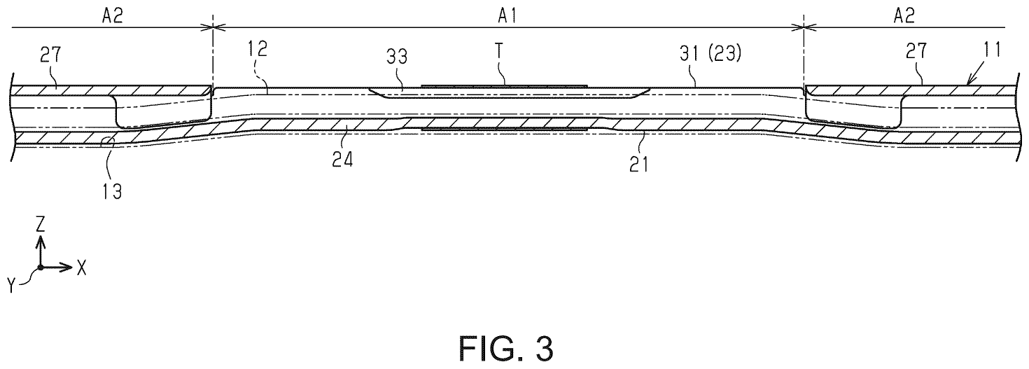

As shown in FIGS. 1 and 2, the housing 21 includes a first range A1, which constitutes an intermediate portion of the housing 21 in the length direction X, and a second range A2, which constitutes a range other than the first range A1. The second range A2 is provided on each side of the first range A1 in the length direction X. The thickness of the housing 21 in the height direction Z is set to be smaller in the first range A1 than in the second range A2 (see FIG. 3). Also, the width direction dimension of the pair of side walls 23 in the second range A2 is set to be smaller than the width direction dimension of a reinforcement side wall 31 having a reinforcement part 32.

The protector 11 is provided with a cover 27 in each second range A2. Note that FIGS. 1 and 2 show a state where the later-described covers 27 of the protector 11 are open, and FIG. 3 shows a state where the covers 27 are closed. Each cover 27 is configured to be able to cover the space between the upper ends of the pair of side walls 23 in the second range A2. The cover 27 is formed in one piece with one of the pair of side walls 23 via a hinge, for example. When the cover 27 is rotated about the hinge and is closed, the cover 27 is detachably engaged with the other side wall 23. The thickness of the cover 27 in the height direction Z is set to be larger than that of a later-described tape T (see FIG. 3).

### Configuration of Reinforcement Side Wall 31

The housing 21 has, in the first range A1, a pair of reinforcement side walls 31, which constitute respective parts of the pair of side walls 23. As shown in FIGS. 2 and 4, the pair of reinforcement side walls 31 face each other in the width direction Y. Each of the reinforcement side walls 31 includes the reinforcement part 32 extending outward in the width direction Y. The reinforcement parts 32 respectively extend outward in the width direction Y from at least the upper ends of the reinforcement side walls 31. The first range A1 is a range of the housing 21 in the length direction X in which the reinforcement parts 32 are formed.

The upper end face of each reinforcement side wall 31 has an inclined portion 33 (incline) that is inclined downward and inward in the width direction Y and is connected to the inner face of this reinforcement side wall 31. The inclined portion 33 is formed in the upper end face of the reinforcement side wall 31 having the reinforcement part 32, partially in the width direction Y. In other words, the inclined portion 33 is formed between the middle position in the width direction Y on the upper end face of the reinforcement side wall 31 having the reinforcement part 32 and the inner face of the reinforcement side wall 31. According to this configuration, it is possible to suppress a reduction in volume of the reinforcement side wall 31 in the present embodiment, compared to a configuration in which the inclined portion 33 is formed over the entire width in the width direction Y of the upper end face of the reinforcement side wall 31. This can contribute to an improvement in rigidity of the reinforcement side wall 31.

One of the pair of reinforcement side walls 31 has a pair of fixing portions 34 that extend from the outer face in the width direction Y of the reinforcement side wall 31. The pair of fixing portions 34 are lined up in the length direction X. Each fixing portion 34 is fixed to a fixing target portion 13a of the bracket 13.

As shown in FIGS. 1 and 2, a tape T is wound, for example, several times around the outer periphery of the housing 21 within the first range A1. The tape T is, for example, an adhesive tape. The tape T covers the space between the upper ends of the pair of reinforcement side walls 31. As a result, the tape T prevents the wires W from protruding in the first range A1.

As shown in FIG. 2, a wrappable range A3 that is wrappable by the tape T is a range in the length direction X between the pair of fixing portions 34. The inclined portion 33 is provided over a range in the length direction X that includes at least the wrappable range A3. In the present embodiment, the dimension of the inclined portion 33 in the length direction X is set to be larger than the wrappable range A3.

As shown in FIG. 3, the top surface of the bracket 13 on which the protector 11 is placed is raised in the height direction Z at the portion corresponding to the first range A1 of the protector 11. In addition, as described above, the top panel is placed above the protector 11. For this reason, the thickness of the housing 21 in the height direction Z is set to be smaller in the first range A1 than in the second range A2. When, with respect to the height direction Z, the upper end positions of the reinforcement side walls 31 are set to be higher than the upper end positions of the side walls 23 in the second range A2, a space for housing the wire group 12 is ensured in the first range A1. In addition, since no cover 27 is set in the first range A1, and the tape T with a small thickness is used as a member that covers the upper portions of the reinforcement side walls 31, a design in which the protector 11 does not interfere with the above-described top panel is realized.

### Functions of Present Embodiment

The following will describe a procedure for manufacturing the wire harness 10.

First, the wire group 12 is housed in the housing 21, and then the wire group 12 is fixed to the protector 11 at each outlet 22 with the binding member 25. Thereafter, the covers 27 are closed.

Then, the tape T is wound around the outer periphery of the housing 21 within the wrappable range A3. At this time, if any wires W ride up on the inclined portion 33 as shown by a two-dotted line in FIG. 4, the wires W are pushed into the housing 21 by the tape T in the process of winding. This can prevent wires W from being taped while riding up on the reinforcement side wall 31. As a result, it is possible to prevent interference of wires W fixed by the tape T while riding up on the reinforcement side wall 31 with the above-described top panel.

The wire harness 10 manufactured in the above-described manner is placed on the bracket 13 and is fixed to the fixing target portion 13a of the bracket 13 by the fixing portions 34. Each connector 14 is then connected to the above-mentioned counterpart connector. If the wire group 12 led out from the outlets 22 is bent as shown in FIG. 1, the bending reaction force of the wire group 12 acting upward in the height direction Z may be applied to both ends of the protector 11 in the length direction X. The rigidity of the protector 11 of the present embodiment is secured by the cover 27 in each second range A2, and is secured by the reinforcement side walls 31 having the reinforcement parts 32 in the first range A1. Therefore, the protector 11 is prevented from being deformed at its two ends in the length direction X to warp upward in the height direction Z due to the bending reaction force of the wire group 12.

### Effects of Present Embodiment

The following will describe effects of the present embodiment.
(1) In the intermediate portion of the housing 21 in the length direction X, each side wall 23 includes the reinforcement side wall 31 having the reinforcement part 32. The upper end face of the reinforcement side wall 31 has the inclined portion 33 that is inclined downward and inward in the width direction Y and is connected to the inner face of the reinforcement side wall 31. As a result of the tape T being wound around the outer periphery of the housing 21 in the range including at least a part of the inclined portion 33 in the length direction X, the space between the upper ends of the pair of reinforcement side walls 31 is closed by the tape T. According to this configuration, if wires W ride up on the inclined portion 33 during tape winding, the wires W will be pushed into the housing 21 by the tape T in the process of winding. In this way, the inclined portion 33 can guide the wires W into the housing 21. Therefore, it is possible to prevent wires W from being taped while riding up on the reinforcement side wall 31.
(2) The housing 21 has the first range A1, which is a part of the housing 21 in the length direction X and includes the reinforcement side walls 31, and the second range A2, which is a range in the length direction X other than the first range A1. The width direction dimension of the pair of side walls 23 in the second range A2 is set to be smaller than the width direction dimension of each of the reinforcement side walls 31 having the reinforcement part 32. The cover 27 is provided in the second range A2. The cover 27 has a thickness in the height direction Z larger than that of the tape T and covers the space between the upper ends of the pair of side walls 23. According to this configuration, since the cover 27 covering the space between the upper ends of the pair of side walls 23 is provided in the second range A2 of the housing 21, it is possible to improve the rigidity of the second range A2 with the cover 27.
(3) The housing 21 has a flattened shape with a small thickness in the height direction Z over the entire length in the length direction X. The thickness of the housing 21 in the height direction Z is set to be smaller in the first range A1 than in the second range A2. According to this configuration, it is possible to ensure the rigidity in the first range A1 with the reinforcement part 32, while reducing the thickness of the housing 21 in the height direction Z in the first range A1.
(4) The inclined portion 33 is formed in the upper end face of the reinforcement side wall 31, partially in the width direction Y. According to this configuration, it is possible to form the inclined portion 33 while securing the volume (i.e., rigidity) of the reinforcement side wall 31.
(5) The reinforcement side wall 31 has a pair of fixing portions 34 that extend from the outer face in the width direction Y of the reinforcement side wall 31 and are lined up in the length direction X. The range in the length direction X between the pair of fixing portions 34 is the wrappable range A3 that is wrappable by the tape T. The inclined portion 33 is provided over a range, in the length direction X, that includes at least the wrappable range A3. According to this configuration, the inclined portion 33 provided over a range including the wrappable range A3 that is wrappable by the tape T can effectively prevent the wires W from riding up on the reinforcement side wall 31.
(6) The pair of reinforcement side walls 31 each including the inclined portion 33 are provided facing each other in the width direction Y. According to this configuration, in the intermediate portion (first range A1) of the housing 21 in the length direction X, each of the pair of side walls 23 is provided with the reinforcement part 32 and the inclined portion 33, so it is possible to further prevent the wire W from being taped while riding up on the reinforcement side wall 31.

### Other Embodiments

The above-described embodiment can be implemented with the following modifications. The above-described embodiment and the following modifications can be implemented in combination with each other to the extent that they are technically consistent.
The number of wires W included in the wire group 12 is not limited to that in the above-described embodiment and can be changed as appropriate according to the configuration of the wire harness 10.
The covers 27 may be separate from the housing 21.
The configuration, such as the shape, of the reinforcement part 32 of each reinforcement side wall 31 is not limited to that in the above-described embodiment and can be changed as appropriate according to the configuration of the wire harness 10.
The inclined portion 33 may be provided in the upper end face of the reinforcement side wall 31, entirely in the width direction Y.
The surface of the inclined portion 33 in the above-described embodiment includes a flat portion, but is not limited to this, and the entire surface of the inclined portion 33 may be a curved surface.
The dimension of the inclined portion 33 in the length direction X may be set to a dimension equivalent to or smaller than the wrappable range A3. The dimension of the inclined portion 33 in the length direction X may be set to be smaller than the dimension of the tape T in the length direction X.
The inclined portion 33 may be provided on only one of the pair of reinforcement side walls 31.
The reinforcement side wall 31 may be provided on only one of the pair of side walls 23.
The configuration of the protector 11 of the above-described embodiment is also applicable to protectors used for devices other than vehicle battery modules.

The embodiments disclosed herein are illustrative in all respect, and the present disclosure is not limited to these examples. That is, the scope of the present disclosure is defined by the claims, and all modifications within the meaning and scope equivalent to the claims are intended to be included.

What is claimed is:

1. A protector comprising:
a housing that has a pair of side walls facing each other in a width direction and a bottom wall connecting lower ends of the pair of side walls, and is configured to house a wire group between the pair of side walls; and
outlets that are provided at both ends of the housing in a length direction of the wire group and are configured to lead the wire group out of the housing, wherein:
the side walls include, in an intermediate portion of the housing in the length direction, a reinforcement side wall that has a reinforcement part extending outward in the width direction from at least an upper end of one of the side walls,
an upper end face of the reinforcement side wall has an incline that is inclined downward and inward in the width direction and is connected to an inner face of the reinforcement side wall, and
a tape is wound around an outer periphery of the housing in a range in the length direction that includes at least a portion of the incline, so that a space between the upper ends of the pair of side walls is closed by the tape.

2. The protector according to claim 1, wherein:
the housing includes a first range, which is a range of the housing in the length direction and includes the reinforcement side wall, and a second range, which is a range in the length direction other than the first range,
a width direction dimension of the pair of side walls in the second range is smaller than a width direction dimension of the reinforcement side wall having the reinforcement part, and
a cover is provided in the second range, the cover having a thickness in a height direction larger than that of the tape and covering the space between the upper ends of the pair of side walls.

3. The protector according to claim 2, wherein:
the housing has a flattened shape with a small thickness in the height direction over an entire length in the length direction, and
a thickness of the housing in the height direction is smaller in the first range than in the second range.

4. The protector according to claim 1,
wherein the incline is formed in the upper end face of the reinforcement side wall, partially in the width direction.

5. The protector according to claim 1, wherein:
the reinforcement side wall has a pair of fixing portions that extend from an outer face in the width direction of the reinforcement side wall and are lined up in the length direction,
a range in the length direction between the pair of fixing portions is a wrappable range that is wrappable by the tape, and
the incline is provided over a range in the length direction that includes at least the wrappable range.

6. The protector according to claim 1, further comprising:
a pair of reinforcement side walls that includes the reinforcement side wall,
wherein the pair of the reinforcement side walls each include the incline and are provided facing each other in the width direction.

7. A wire harness comprising:
the protector according to claim 1; and
a wire group passing through the protector.
